(19) United States
(12) Patent Application Publication
(10) Pub. No.: US 2008/0266606 A1
(43) Pub. Date: Oct. 30, 2008

(54) OPTIMIZED PRINT LAYOUT

(76) Inventor: Geoffrey W. Huenemann, Vancouver (CA)

Correspondence Address: David A. Novais;Patent Legal Staff, Eastman Kodak Company, 343 State Street, Rochester, NY, 14650-2201, US

(21) Appl. No.: 11/739,140

(22) Filed: Apr. 24, 2007

(51) Int. Cl. G06K 15/00

(52) U.S. Cl. 358/1.18

(57) ABSTRACT

Imposition software produces an imposition plan for a layout of printing elements (1). A nominal layout (10) including printing elements (1) with nominal displacements (12) identified. The imposition plan is optimized by reducing a displacement (12) between the printing elements (1). The amount that the displacement (12) can be reduced is determined by analyzing overlaps (22) in printing element content that may occur to ensure that the overlap (22) is beneficial.

### FIELD OF THE INVENTION

This invention pertains to print imposition and in particular to optimizing a layout of imposed elements based on the nature of their content definition.

### BACKGROUND OF THE INVENTION

Printing elements such as document pages, business cards, photographic images and the like have been printed in the art using imposition to improve efficiency. Imposition software is one means for defining a layout of printing elements on a printing medium. Imposition software can be used to manually or automatically determine a plan for a layout of elements on one or more printing sheets so that the printed sheet signatures can be cut, assembled and finished according to a desired method. Imposition software can also be used to manually or automatically determine a plan for repeatedly printing one or more elements on a single sheet of paper in order to increase printing efficiency.

Printing elements used in relation to imposition software are typically specified in electronic files such as an image file (e.g. TIFF or JPG), artwork file (e.g. EPS) or page description file (e.g. PS or PDF). Electronic files can include or be associated with geometry information for the printing elements. Various geometries can be associated with a printing element to identify various portions of the printing element. These geometries can be used by imposition software when arranging printing elements. Geometry information can be specified by the originator of the printing element or defined afterward. For example, a printer receiving a printing element file may associate geometry information with the element if none exists or may change existing geometry information. Additionally, a printer may alter the printing element to improve its printability (e.g. add bleed or trap content).

FIG. 1 illustrates an exemplary printing element 1 with exemplary associated geometry information. Printing element 1 can correspond to a PDF file defining the printing content, including artwork 2 and text 4, defined, for example, as vector elements and/or as raster. Printing element 1 is associated with an art box 3, which is one type of geometry information defining the intended boundary of artwork 2. Printing element 1 is also associated with trim box 5, defining the intended boundary of artwork 2 (flag) and text 4 (caption). The geometry of trim box boundary 5 defines the dimensions of printing element 1 after finishing (e.g. trimming). Printing element 1 is also associated with bleed box 6, defining the boundary of bleed 7. Bleed 7 can be added when part of printing element 1 is specified immediately adjacent a boundary defined by trim box 5. This is done to compensate for inaccuracies in a finishing process (e.g. trimming) or the printing process. For example, each vertical stripe of artwork 2 is immediately adjacent a vertical and horizontal boundary defined by trim box 5 and colored bleed 7 is defined accordingly as part of printing element 1.

Prior art imposition software could use dimensions derived from art box boundary 3, trim box boundary 5, and/or bleed box boundary 6 when determining a layout including printing element 1. For example, it is common to arrange printing element 1 based on its bleed box boundary 6 dimensions so that printing element 1 does not overlap content of adjacent printing elements. To provide additional displacement between elements, imposition software can, for example, configure a gutter between elements. This can be done, for example to leave room for imposition marks, or to accommodate a finishing process (e.g. binding), or to ensure that printing content does not abut.

FIG. 2 illustrates an exemplary nominal layout 10A produced by imposition software according to the prior art. Nominal layout 10A is based on an imposition plan that provides a 2×2 arrangement of copies of printing element 1 on printing medium 11A. The imposition plan defines a vertical displacement 12A and horizontal displacement 12B to provide a nominal displacement between printing elements 1A-1D. Note that a small amount of the lower and right portions of printing medium 11A remain unprinted by nominal layout 10A and would be removed during finishing.

It may be desirable to reduce the displacement between some adjacent printing elements in a layout to reduce costs by optimizing the utilization of resources such as paper, ink and press time. In particular, reducing the displacement so that a single cut instead of two cuts can be very advantageous. However, prior art imposition programs have not considered analyzing content of adjacent printing elements to determine whether their displacement can be reduced to the point where portions of adjacent printing elements overlap without affecting the finished result. When content for an optimized layout is printed where content overlaps and is sufficiently similar, the visual result should be unnoticeable to the print buyer.

### SUMMARY OF THE INVENTION

The present invention provides methods and systems for automatically reducing the displacement between printing elements in an imposition plan based on analyzing content defined by the printing elements. In particular, an imposition plan for a nominal layout can be determined for printing elements based on geometry information associated with the elements to be imposed. In one embodiment, an optimized layout can be produced by reducing the displacement between adjacent printing elements based on analyzing overlapping content, identified in part by boundaries of the printing elements, to ensure that the overlapping content is sufficiently similar. In one embodiment, an optimized layout can also be produced by considering variations in the nominal layout to enable further reductions in displacements between adjacent printing elements.

### BRIEF DESCRIPTION OF THE DRAWINGS

FIG. 1 illustrates an exemplary printing element with exemplary associated geometry information.

FIG. 2 illustrates an exemplary layout produced by imposition software according to the prior art.

FIG. 3 illustrates an exemplary layout produced by imposition software according to the present invention.

FIG. 4A illustrates three adjacent printing elements of different sizes in an exemplary nominal layout.

FIG. 4B illustrates an exemplary candidate for an optimized layout depicting areas where portions of printing elements overlap.

FIG. 4C illustrates an exemplary candidate for an optimized layout of irregularly shaped printing elements.

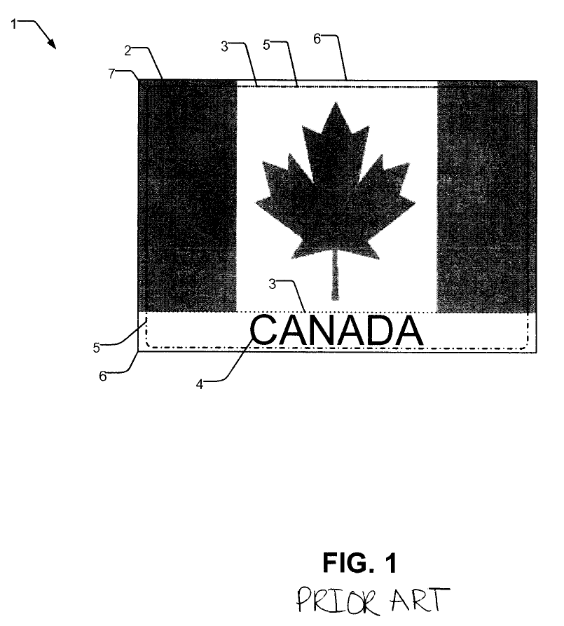

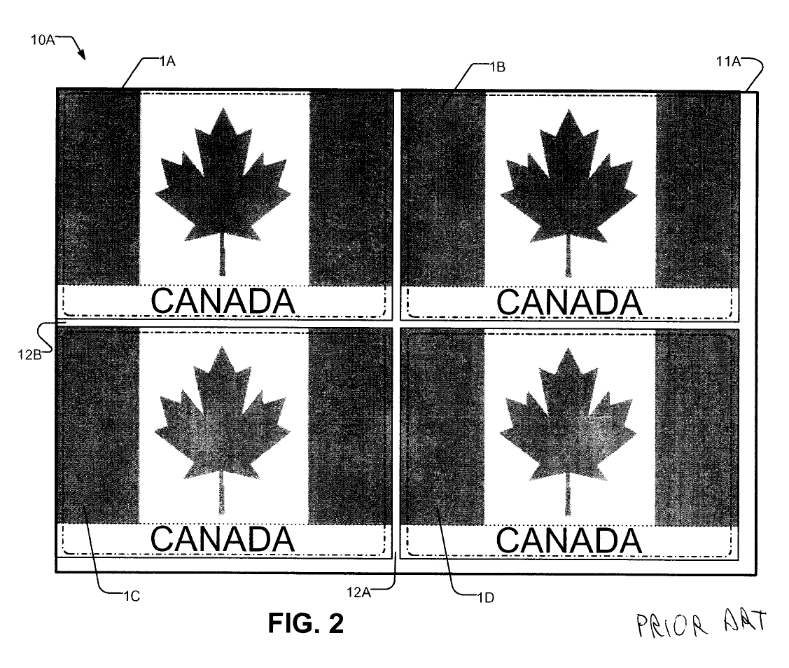

### DETAILED DESCRIPTION OF THE INVENTION

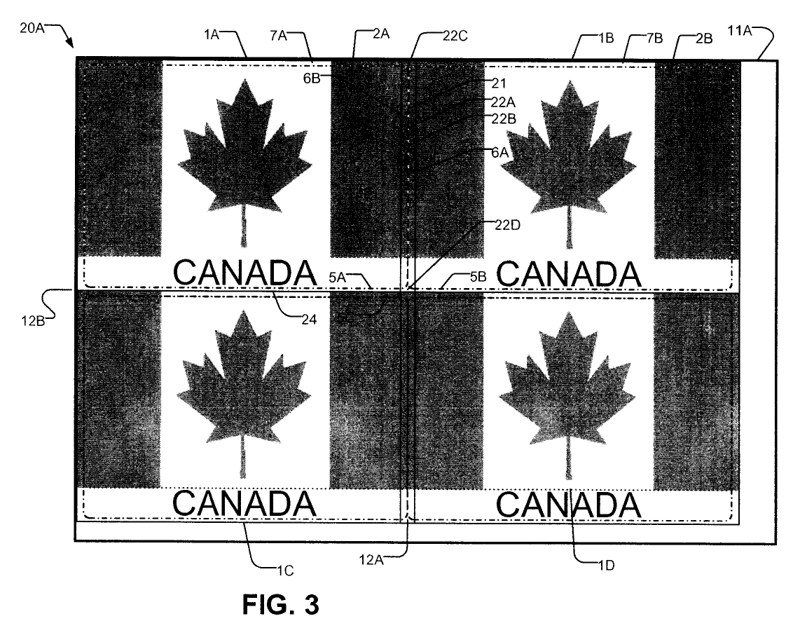

FIG. 3 illustrates an exemplary optimized layout 20A produced by imposition software according to the present invention. Imposition software can be operated on a desktop or server computer in either an automated or interactive mode. In one embodiment, imposition software can automatically produce an imposition plan for optimized layout 20A from a user request for an imposition. For example, a user request may request 64-up imposition with a desire to maximize per-media utilization. Depending on the dimension of the content and allowable media sizes, different impositions could result (e.g. 2×32, 4×16, 8×8). As another example, a user may request an optimized imposition for a quantity of each of a set of printing elements 1 based on a set of available media sizes with a desire to minimize media waste. As another example, a user may request an optimized imposition for an underutilized printing device that supports certain media sizes.

In some embodiments, an imposition plan for a nominal layout 10A can first be produced as an intermediate step by imposition software. The intermediate imposition plan need not be presented to the user or stored for later use but can be used by the imposition software as a basis for producing an optimized imposition plan. A series of imposition plans for different nominal layouts 10A can be produced and optimized to determine which optimized layout is preferred based on predefined or user-defined criteria.

In some embodiments, the user can identify the imposition plan for nominal layout 10A and the imposition software can automatically produce the imposition plan for optimized layout 20A. For example, a user can identify a predefined 64-up imposition plan that may be able to be optimized based on the nature of the printing elements 1 being imposed.

For the example of FIG. 3, assume that the imposition plan for nominal layout 10A has been produced through prior art methods and the user has requested that imposition software optimize the imposition plan for nominal layout 10A. In the plan for optimized layout 20A, imposition software has reduced the horizontal displacement between printing elements 1A and 1B so that trim boxes 5A and 5B abut coincident with line 21. By reducing the displacement, overlap area 22A, bounded by bleed box 6B and trim box 5A, includes an overlap between bleed 7B and artwork 2A. Since bleed 7B and artwork 2A define the same content throughout overlap area 22A, no undesirable printed result will occur. However, utilization of printing medium and printing colorants will be beneficially reduced. Similarly, overlap area 22B includes a beneficial overlap between bleed 7A and artwork 2B. Overlap area 22C includes a beneficial overlap between bleed 7A and bleed 7B. Overlapped areas where no content is defined by at least one printing element can be considered a beneficial overlap (e.g. overlap area 22D).

Imposition software can check for and analyze overlapped content (e.g. corresponding to areas 22A-22D) through a variety of means. For example, vector content corresponding to bleed 7B and artwork 2A can be compared using vector comparison methods. As another example, vector elements of overlap area 22A can be rendered and pixels values compared. Rendering can be performed at different resolutions. In one embodiment, rendering at the resolution intended for the final printed result is performed since the comparison will be consistent with the final result. Rendering at a lower resolution can be faster but, depending on the content, comparing may identify some overlapping pixels as similar but different, especially near the boundary of an overlapped area.

In some embodiments, it may be desirable to establish criteria for determining whether overlapped content is sufficiently similar that overlapping would produce acceptable printed results. For example, if only small portions of overlapped content differ, the result may be acceptable. As another example, if portions of overlapped content have different but similar color values the result may be acceptable. In some embodiments, thresholds can be established for comparison results to automatically determine the degree of acceptable variance. As another alternative, when comparing with low resolution, portions that are different can be re-rendered at higher resolution and compared again. In some embodiments, the user can be presented with an indication of the degree of difference and be requested to confirm the optimization. The indication can include a preview of the overlapped area to enable the user to visually determine whether the overlap is acceptable.

In some embodiments, the imposition software can determine the plan for optimized layout 20A by first determining portions of adjacent boundaries between two or more printing elements 1. This can be done by examining geometry information associated with printing elements 1 and/or the imposition plan for nominal layout 10A. Then, the software can proceed by determining the nominal displacement between the boundaries. The software then proceeds by reducing the displacement between the printing elements and their associated boundaries and comparing the overlapped content of the printing elements 1. In some embodiments, the displacement can be reduced iteratively to identify a preferred displacement reduction. This process can then be repeated for different sets of printing elements 1 referenced by the imposition plan for nominal layout 10A.

For example, vertical portions of adjacent bleed boxes 6A and 6B can be identified as adjacent boundaries. Their horizontal displacement can be calculated, for example, either directly from geometry information from the imposition plan (e.g. gutter associated with displacement 12A) or based on plan-defined positions of printing elements 1A and 1B (e.g. their centers) and the geometry of their bleed box boundaries 6. Then, the horizontal displacement between bleed box boundaries 6A and 6B can be reduced to a negative value as depicted in FIG. 3. Alternatively, other boundaries, such as vertical portions of trim box 5A and 5B can be used in the process with their displacement reduced to zero.

In some embodiments, iterative displacement reduction can occur by decreasing displacement by a predetermined amount until comparison identifies sufficient dissimilarity. In another embodiment, iteration can be based on the geometry of adjacent boundaries. For example, displacement can be reduced first so that trim box boundaries 5A and 5B abut (as shown), then so that bleed box boundary 6A abuts trim box 5B (e.g. overlapped bleeds in this example) and then so that bleed box boundaries 6A and 6B abut (e.g. zero gutter in this example). Other iterative displacement reduction means can also be employed including for example various searching means to find the preferred displacement reduction.

Reducing displacement can be performed by a variety of means. In some embodiments this can include modifying the position of printing elements 1 in the imposition plan. This can be useful where an irregular arrangement of different printing elements 1 exists. In some embodiments, more suitable for regular arrangements, a reduction in displacement 12A can be accomplished by allowing specification of a negative value for gutter associated with displacement 12A.

For regular arrangements of different printing elements 1 (e.g. different pages), reducing displacement can be controlled by concurrently reducing displacement between sets of adjacent printing elements 1. For example, in a 3×3 layout of different printing elements 1, a reduction in displacement between the first and second row of the layout could be limited to the minimum acceptable reduced displacement calculated for vertically adjacent printing elements 1 in each column of the layout.

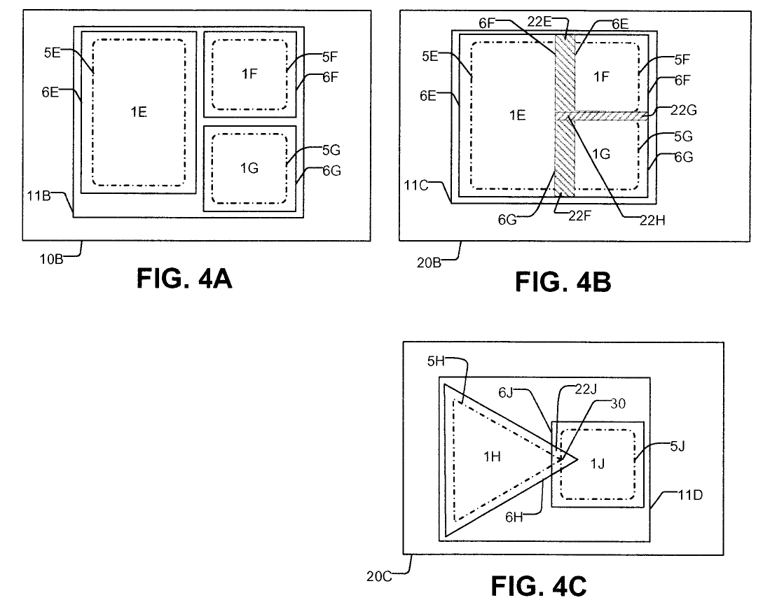

For irregular layouts of printing elements 1, comparisons between more than two printing elements 1 can be performed to determine an acceptable displacement reduction. For example, FIG. 4A illustrates three adjacent printing elements (1E, 1F and 1G) of different sizes in an exemplary nominal layout 10B. Note that only selected boundaries of printing elements 1 are illustrated and their content is not shown. The nominal positions for printing elements 1E-1G can cause identification of adjacent boundaries including vertical boundaries corresponding to vertical portions of bleed boxes 6F, 6G and 6H. Note that a portion of printing medium 11B below printing element 1F will be wasted as it contains no printing element 1.

FIG. 4B illustrates an exemplary candidate for an optimized layout 20B depicting areas 22 where portions of printing elements 1E, 1F and 1G overlap. Overlap areas 22E and 22F, illustrated with diagonal shading, corresponds to overlaps between portions of element 1E and elements 1F and 1G respectively. These overlaps result from a horizontal displacement reduction. Similarly, overlap area 22G, illustrated with different diagonal shading, corresponds to overlap between elements 1F and 1G due to a vertical displacement reduction. Overlap area 22H, illustrated as cross-hatched shading, corresponds to overlap between elements 1E, 1F and 1G resulting from a reduction in both horizontal and vertical displacements. Overlapped content for printing elements 1E, 1F and 1G in overlap areas 22A-22H can be compared to determine whether the overlapping content is sufficiently similar. Assuming that the overlapped content is sufficiently similar, a reduced size of printing medium 11C can be used for layout 20B to reduce waste when compared with nominal layout 10B.

FIG. 4C illustrates an exemplary candidate for an optimized layout 20C of irregularly shaped printing elements 1H and 1J. In this example, two portions of bleed box 6H are adjacent one portion of bleed box 6J. Values for their nominal and reduced displacement can be based on selected boundary points 30. Points 30, as illustrated, coincide for layout 20C and correspond to a vertex of trim box 5H and a midpoint of a vertical portion of trim box 5J. Similar to methods described above, content (not shown) for printing elements 1H and 1J corresponding to overlap area 22J, illustrated with shading, can be compared before accepting the candidate imposition plan for optimized layout 20C.

In some embodiments, variations in the nominal layout 10A, 10B can be iteratively examined to determine if one variation allows a preferred optimization. For example, each printing elements 1 can be rotated by different amounts (e.g. 90 degrees or 180 degrees) to determine if the varied nominal layout 10 allows a preferred reduction in displacement. In the example of FIG. 3, nominal layout 10A could be varied by rotating printing elements 1A-1D so that their top sides are adjacent. This would allow both vertical and horizontal displacements to be reduced so that their trim box boundaries 5 abut. This variation could use less media and ink and simplify cutting further than optimized layout 20A.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the scope of the invention.

### PARTS LIST

1 printing element
1A-H printing element
1J printing element
2 artwork
2A artwork
2B artwork
3 art box boundary
4 text
5 trim box boundary
5A-5C trim box boundary
6 bleed box boundary
6A bleed box boundary
6B bleed box boundary
6F-6H bleed box boundary
6J bleed box boundary
7 bleed
7A bleed
7B bleed
10A nominal layout
10B nominal layout
11A printing medium
12A displacement
12B displacement
20A-20C optimized layout
21 line
22A-22H overlap area
22J overlap area
30 boundary point

1. A computerized imposition method, comprising:
obtaining a first and second printing element wherein each printing element is associated with geometry information specifying a plurality of boundaries associated with the printing element;
identifying an imposition for a nominal layout of the first and second printing elements wherein the imposition specifies a displacement between the printing elements; and
producing an imposition for an optimized layout by automatically reducing the displacement between the first and second printing elements based on content defined by the printing elements.

2. A method according to claim 1 wherein reducing the displacement between the first and second printing elements based on content defined by the printing elements comprises:
determining a candidate amount for reducing the displacement;
identifying an overlap area wherein the first and second printing elements overlap due to the candidate amount for reducing the displacement;
determining whether overlapping content of the first and second printing elements in the overlap area is sufficiently similar; and
reducing the displacement between the first and second printing elements by the candidate amount if the result of determining is positive.

3. A method according to claim 2 including an iterative process for determining the preferred candidate amount for reducing the displacement.

4. A method according to claim 2 wherein determining whether overlapping content of the first and second printing elements in the overlap area is sufficiently similar includes comparing overlapping portions of content of the first and second printing elements.

5. A method according to claim 4 wherein comparing overlapping portions of content of the first and second printing elements comprises comparing overlapping vector content elements based on similarity criteria.

6. A method according to claim 4 wherein comparing overlapping portions of content of the first and second printing elements comprises rendering the printing elements to a bitmap format and performing a pixel-wise comparison.

7. A method according to claim 4 including determining that the overlapping portions of content are sufficiently similar based on similarity criteria.

8. A method according to claim 7 wherein the similarity criteria includes at least one threshold for an acceptable degree of difference determined by comparing.

9. A method according to claim 8 wherein the at least one threshold includes one or more of a threshold for an acceptable amount of per-area color value variance; a threshold for an acceptable color variance in an area; and a threshold for an acceptable portion of an area having different color values.

10. A method according to claim 4 wherein a user determines whether the overlapping portions of content are sufficiently similar based on the results of the comparison.

11. A method according to claim 1 wherein identifying the imposition for the nominal layout includes creating the imposition for the nominal layout based on input from a user.

12. A method according to claim 11 including:
creating a set of candidate impositions for the nominal layout;
producing a corresponding set of impositions for optimized layouts from the set of candidate impositions for the nominal layout; and
selecting the imposition for the optimized layout based on an optimization criteria.

13. A method according to claim 12 wherein the optimization criteria includes at least one of increased per-media utilization, reduced media waste, simplified cutting, and increased usage of underutilized printing devices.

14. A method according to claim 1 wherein the plurality of boundaries include at least a boundary for trimming and a boundary for bleed.

15. A method according to claim 2 wherein the overlap area is defined in part by boundaries associated with the first and second printing elements.

16. A method according to claim 1 wherein reducing the displacement between the first and second printing elements comprises reducing a value for a gutter parameter of the imposition.

17. A method according to claim 1 wherein reducing the displacement between the first and second printing elements comprises modifying the position, in the imposition, of at least one of the first and second printing elements.

18. A method according to claim 1 including identifying a variation in the nominal layout and producing an imposition for an optimized layout based on the variation in the nominal layout.

19. A method according to claim 18 wherein identifying the variation in the nominal layout includes rotating at least one printing element of the nominal layout.

20. A medium carrying a set of computer-readable signals comprising instructions which, when executed by a data processor, cause the data processor to execute a method according to claim 1.
